(19) United States
(12) Patent Application Publication
(10) Pub. No.: US 2009/0105909 A1
(43) Pub. Date: Apr. 23, 2009

(54) Rotational angle detecting device

(75) Inventor: Satoshi Yamaguchi, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: NILES CO., LTD., Tokyo (JP)

(21) Appl. No.: 12/285,344

(22) Filed: Oct. 2, 2008

(30) Foreign Application Priority Data
Oct. 19, 2007 (JP) 2007-272330

(51) Int. Cl. B62D 6/00

(52) U.S. Cl. 701/41

(57) ABSTRACT

In a steering angle detecting device for a steering shaft, gear tooth omission abnormality is detected with high accuracy without causing an increase in costs. A speed increasing side detecting gear and a speed reduction side detecting gear are rotated in conjunction with a rotor gear integral with a steering shaft, operation processing of sampling data from MR sensors 7a and 7b provided to be attached to both the detecting gears is performed in a speed increasing mechanism side operation part 60 and a speed reducing mechanism side operation part 70 to calculate a speed increase angle and a speed reduction angle of the steering shaft. In a failure diagnosis part 80, respective moving average values of the speed increase angle and the speed reduction angle are calculated in a speed increase angle moving averaging processing part 81 and a speed reduction angle moving averaging processing part 82, a difference of each of the moving average values is calculated in a difference calculating part 84, and when a displacement amount of the difference at each sampling obtained in a displacement amount calculating part 86 is larger than a reference value S0, an abnormality detecting part 88 outputs an abnormality signal to the effect that any of conjunction systems of the respective gears has gear tooth omission abnormality.

### CROSS-REFERENCE TO RELATED APPLICATION

This application claims priority under 35 USC 119 from Japanese Patent Application No. 2007-272330, the disclosure of which is incorporated by reference herein.

### BACKGROUND OF THE INVENTION

1. Field of the Invention

The present invention relates to a rotational angle detecting device for detecting a steering angle or the like of a steering shaft attached to a vehicle.

2. Description of the Related Art

Conventionally, as a rotational angle detecting device, there has been a steering angle detecting device which detects the steering angle of the steering shaft connected to the steering wheel of a vehicle, and outputs the detection result to another control device and the like.

In such a detecting device, a rotor gear is fitted on a steering shaft, a magnet is attached to a rotational angle detecting gear connected to the rotor gear, and an MR sensor is placed on a fixed side to be opposed to the magnet, thereby detecting the rotating state of the rotational angle detecting gear.

The output of the rotational angle detecting device is used for controlling the other devices, and therefore, abnormality detection is needed for ensuring reliability of the detection accuracy.

Thus, in the rotational angle detecting device which has been previously proposed by the applicant in Japanese Patent Laid-Open No. 2002-213944, a plurality of rotational angle detecting gears to which magnets are attached are used, MR sensors are opposed respectively to the rotational angle detecting gears, and determination of abnormality of the MR sensor is made by comparing the rotational angles which are calculated in both the systems, because the rotational angles based on the outputs from these two systems are assumed to be substantially the same value as each other.

In order to increase the advantage in a case of using a plurality of rotational angle detecting gears, the present applicant has proposed a rotational angle detecting device by Japanese Patent Application 2006-228581. In the rotational angle detecting device, a speed increasing side detecting gear which rotates more with respect to the rotational frequency of the steering shaft is adopted as one of a plurality of rotational angle detecting gears, and a speed reducing side detecting gear which rotates less with respect to the rotation of the steering shaft is adopted as the other rotational angle detecting gear.

In this device, when the steering shaft is rotated from the maximum rotation position in the right direction to the maximum rotation position in the left direction, the speed increasing side detecting gear makes a plurality of rotations, whereas the speed reducing side detecting gear makes one rotation, for example.

Thereby, the detailed absolute angle (hereinafter, the speed increase angle) of steering with high resolution is obtained from the rotational angle of the speed increasing side detecting gear, whereas the rough absolute angle (hereinafter, the speed reduction angle) is obtained from the rotational angle of the speed reducing side detecting gear, and from the combination of both of the detailed absolute angle and the rough absolute angle, the steering angle of the steering shaft is detected with high accuracy.

Incidentally, as a failure of the rotational angle detecting device, angle skip due to omission of a tooth sometimes occurs to the rotational angle detecting gear and the like.

In this case, a considerable difference of the rotational angles calculated by both the systems naturally occurs, and the difference is expected to be detected as abnormality from comparison of the rotational angles.

However, when the speed increase angle and the speed reduction angle are actually obtained in the normal state without tooth omission in the gears with respect to the rotational angle detecting device using the speed increasing side detecting gear and the speed reducing side detecting gear as in the case of Japanese Patent Application No. 2006-228581, the speed increase angle and the speed reduction angle are unstable as shown in FIG. 6.

In FIG. 6, the broken line indicates the deviation amount of the speed increase angle with respect to the encoder angle when the steering shaft is returned to the neutral position after being turned from one lock end where the steering shaft is fully turned to the other lock end through the neutral position, and the solid line indicates the deviation amount of the speed reduction angle with respect to the speed increase angle. The encoder angle is a real rotational angle based on the output of the encoder attached to the steering shaft.

The speed increase angle substantially corresponds to the actual rotation of the steering shaft expressed by the encoder angle, whereas the speed reduction angle varies with a large deflection of about 10 to 15° with large noise and undulation.

Further, FIG. 7 shows the relationship of the speed increase angle and the speed reduction angle when the rotor gear has tooth omission. Here, it is found out that a deviation also occurs to the speed increase angle with respect to the encoder angle due to tooth omission, and the deflection range of the speed reduction angle is extremely large as in the case of FIG. 6.

The reason why the deflection range of the speed reduction angle is so large is considered to be due to mechanical and structural accuracy. It is found out that if such a large variation is required to be accepted from the viewpoint of costs, it is difficult to set a threshold value for discriminating presence and absence of tooth omission by comparing the data of FIGS. 6 and 7 and timing of the data sampling even if the speed increase angle and the speed reduction angle are to be simply compared, and reliable abnormality detection cannot be performed for tooth omission.

In view of the above, there exists a need for a rotational angle detecting device which overcomes the above mentioned problems in the conventional art.

The present invention addresses this need in the conventional art as well as other needs, which will become apparent to those skilled in the art from this disclosure.

### SUMMARY OF THE INVENTION

Consequently, the present invention is made in view of the above described problems, and has an object to detect tooth omission abnormality of a gear with high accuracy without causing an increase in costs in a steering angle detecting device of a steering shaft using a speed increase angle and a speed reduction angle.

According to an aspect of the present invention, a rotational angle detecting device comprises a rotor gear rotating integrally with a measurement target rotating element, a first driven gear and a second driven gear rotating in conjunction with the rotor gear, a first angle sensor provided to be attached to the first driven gear to detect a periodic angle position of the first driven gear, a second angle sensor provided to be attached to the second driven gear to detect a periodic angle position of the second driven gear, first angle calculating means which performs operation processing of sampling data from the first angle sensor to calculate a first absolute rotational angle of the measurement target rotating element, and second angle calculating means which performs operation processing of sampling data from the second angle sensor to calculate a second absolute rotational angle of the measurement target rotating element. The rotational angle detecting device further comprises moving averaging processing means which calculates respective moving average values of the first absolute rotational angle and the second absolute rotational angle, difference calculating means which calculates a difference between the moving average value of the first absolute rotational angle and the moving average value of the second absolute rotational angle, displacement amount calculating means which calculates a displacement amount of the difference at each sampling, and abnormality detecting means which outputs an abnormality signal to an effect that any of interlocking systems of the respective gears has gear tooth omission abnormality when the displacement amount exceeds a predetermined reference value range.

According to the aspect of the present invention, after the deviation of the first absolute rotational angle calculated based on the detection data by the first angle sensor and the second absolute rotational angle calculated based on the detection data by the second angle sensor is obtained as the difference of the moving average values, the displacement amount of the difference of the previous time and the difference of the present time at each sampling is monitored, and as a result, a large deflection which extremely differs from the other portions appears at the angle position corresponding to the tooth omission. Therefore, tooth omission abnormality of the gear can be detected clearly.

### BRIEF DESCRIPTION OF THE DRAWINGS

Other objects, features, and advantages of the present invention will become more apparent from the following detailed description made with reference to the accompanying drawings, in which like parts are designated by like reference numbers and in which:

FIG. 1 is a diagram showing the arrangement and configuration of a sensor part;

FIG. 2 is a block diagram showing the entire configuration of a steering angle detecting device;

FIG. 3 is a flowchart showing the flow of abnormality detection processing;

FIG. 4 is a diagram showing the deviation amounts of calculated angles using moving average values;

FIG. 5 is a diagram showing the displacement amounts of the deviation amounts of the calculated angles using moving average values;

FIG. 6 is a diagram showing a comparative example of the deviation amounts of the calculated angles in the case without abnormality; and

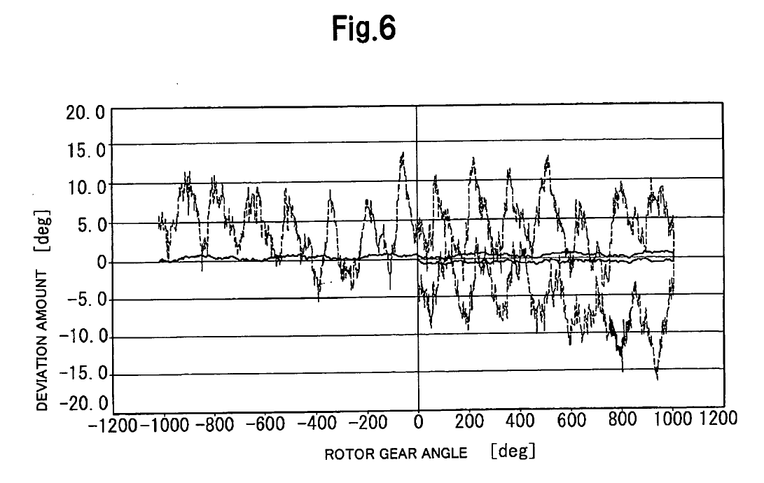

FIG. 7 is a diagram showing a comparative example of the deviation amounts of the calculated angles when a gear has tooth omission.

### DETAILED DESCRIPTION OF THE PREFERRED EMBODIMENT

An embodiment of the present invention applied to detection of the steering angle of a steering shaft will be described with reference to the accompanying drawings.

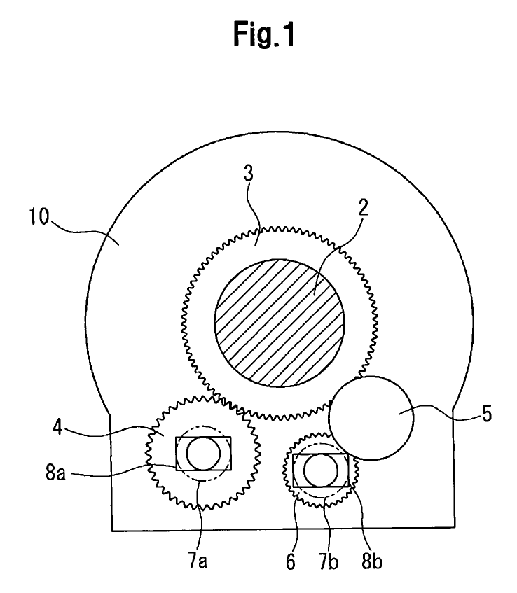

FIG. 1 shows the arrangement and configuration of a sensor part in a rotational angle detecting device.

A rotor gear 3 is fixed to a steering shaft 2 which penetrates through a case base plate 10 on a fixed side. A speed increasing side detecting gear 4 which is rotatably supported on the case base plate 10 is meshed with the rotor gear 3.

The speed increasing side detecting gear 4 rotates so as to be increased in speed in conjunction with the rotation of the rotor gear 3.

A speed reducing side detecting gear 6 is connected to the rotor gear 3 via a speed reduction mechanism 5, and is rotatably supported on the case base plate 10. The speed reduction mechanism 5 is meshed with the rotor gear 3, and reduces the speed of the rotation of the rotor gear 3 to transmit the rotation to the speed reducing side detecting gear 6 by a planetary gear mechanism internally included in the speed reduction mechanism 5.

Magnets 8a and 8b are embedded in the peripheries of the respective rotating shafts of the speed increasing side detecting gear 4 and the speed reducing side gear 6.

On a case cover not illustrated which covers the speed increasing side detecting gear 4 and the speed reducing side detecting gear 6, an MR sensor 7a for detecting the rotating state of the speed increasing side detecting gear 4 is mounted to the position opposed to the magnet 8a of the speed increasing side detecting gear 4, and an MR sensor 7b is mounted to the position opposed to a magnet 8b of the speed reducing side detecting gear 6.

When the driver of a vehicle rotates the steering wheel, the steering shaft 2 connected to the steering wheel rotates, and the rotor gear 3 rotates.

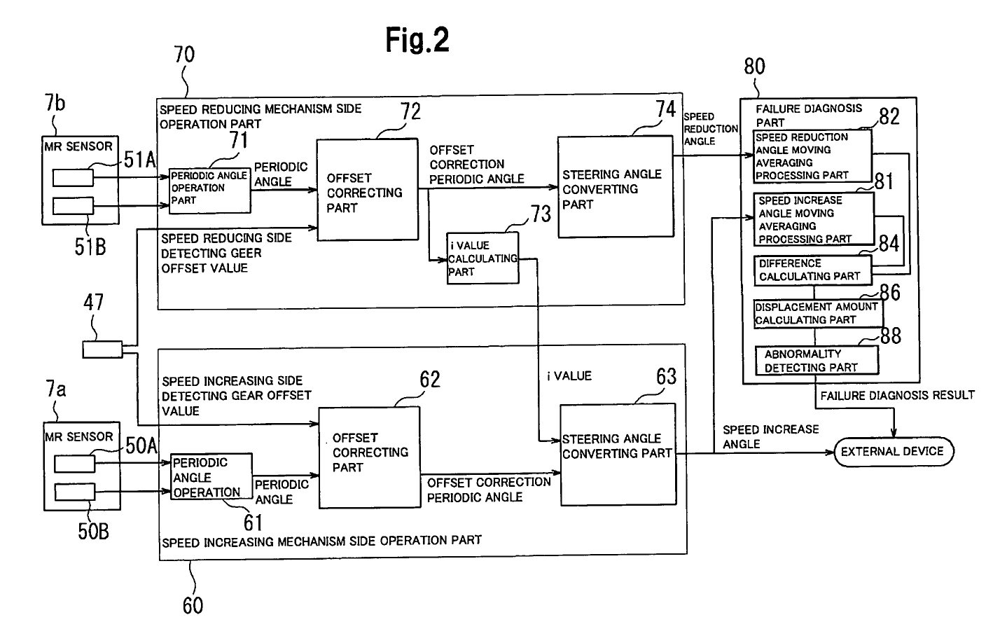

As shown in FIG. 2 which is will be described later, the MR sensor 7a includes a first detecting part 50A and a second detecting part 50B, and outputs two waveforms differing in phase by 90° in accordance with the rotation of the magnet 8a fitted in the speed increasing side detecting gear 4. Similarly, the MR sensor 7b includes a first detecting part 51A and a second detecting part 51B, and outputs two waveforms differing in phase by 90° in accordance with the rotation of the magnet 8b fitted in the speed reducing side detecting gear 6.

FIG. 2 is a block diagram showing the entire configuration of the rotational angle detecting device.

The rotational angle detecting device includes a speed increasing mechanism side operation part 60 to which the MR sensor 7a is connected, a speed reducing mechanism side operation part 70 to which the MR sensor 7b is connected, and a failure diagnosis part 80 which is connected to the speed increasing mechanism side operation part 60 and the speed reducing mechanism side operation part 70.

The speed increasing mechanism side operation part 60 and the speed reducing mechanism side operation part 70 respectively perform operations based on the outputs of the MR sensors 7a and 7b, and output the absolute angles of the rotation of the steering shaft 2.

The failure diagnosis part 80 detects tooth omission abnormality of a gear based on the outputs of the speed increasing mechanism side calculation part 60 and the speed reducing mechanism side calculation part 70.

The speed reducing mechanism side calculation part 70 includes a periodic angle operation part 71, an offset correcting part 72, an i value calculating part 73 and a steering angle converting part 74.

The periodic angle calculating part 71 performs sampling of the outputs from the first detecting part 51A and the second detecting part 51B of the MR sensor 7b every 10 msec, and obtains the periodic angle of the speed reducing side detecting gear 6 from the waveforms differing in phase by 90°. For the method for calculating the angle from the waveforms differing by 90°, a known method can be used.

As for the periodic angle of the speed reducing side detecting gear 6, one period corresponds to the rotation of the steering wheel from one lock position to the other lock position.

The offset correcting part 72 performs correction of the periodic angle calculated by the periodic angle operation part 71 by using the speed reducing side detecting gear offset value stored in an EEPROM 47.

The correction is to convert the periodic angle into an angle with the straight-ahead position of a vehicle as the reference by adding the speed reducing side detecting gear offset value to the periodic angle.

As the speed reducing side detecting gear offset value, the value which is set in advance is stored in the EEPROM 47 together with a speed increasing side detecting gear offset value which will be described later.

By correction of the offset correcting part 72, an offset correction periodic angle is obtained.

Next, the steering angle converting part 74 converts the offset correction periodic angle corrected by the offset correcting part 72 into an absolute angle of the steering shaft 2 and sets the absolute angle as the speed reduction angle.

Here, the rotation of the speed reducing side detecting gear 6 is decelerated with respect to the rotation of the rotor gear 3 which rotates integrally with the steering shaft 2, and therefore, the steering angle converting part 74 converts the offset correction periodic angle into the absolute angle of the steering shaft 2 by multiplying the offset correction periodic angle by its deceleration ratio.

The speed reduction angle converted by the steering angle converting part 74 becomes the approximate absolute angle of the steering shaft 2.

The i value calculating part 73 calculates the i value corresponding to the offset correction periodic angle corrected by the offset correction part 72.

The i value expresses the rotational angle of the steering shaft 2 in the unit of 90° by dividing the rotational angle from one lock position to the other lock position of the steering wheel at each 90° to the left and the right with the straight-ahead position of the vehicle as the center.

The i value calculating part 73 outputs the calculated i value to the speed increasing mechanism side operation part 60 side.

Next, the processing in the speed increasing mechanism side operation part 60 will be described.

The speed increasing mechanism side operation part 60 includes a periodic angle operation part 61, an offset correcting part 62, and a steering angle converting part 63.

The periodic angle operation part 61 obtains the periodic angle of the speed increasing side detecting gear 4 from the waveforms differing in phase by 900, which are outputted from the first detecting part 50A and the second detecting part 50B of the MR sensor 7a as the above described periodic angle operation part 71.

As for the periodic angle of the speed increasing side detecting gear 4, one period corresponds to the rotation at 90° of the steering wheel.

The offset correcting part 62 performs correction of the periodic angle calculated by the periodic angle operation part 61 by using the speed increasing side detecting gear offset value stored in the EEPROM 47 as the above described offset correcting part 72.

By correction of the offset correcting part 62, the offset correction periodic angle can be obtained.

Next, the steering angle converting part 63 converts the offset correction periodic angle into an absolute angle of the steering shaft 2 by using the i value outputted from the speed reducing mechanism side operation part 70 to set the absolute angle as the speed increase angle.

More specifically, the rotation of the speed increasing side detecting gear 4 is accelerated to be twice as high as the rotation of the rotor gear 3 which rotates integrally with the steering shaft 2. Therefore, the offset correction periodic angle is divided by two, and the value which is obtained by multiplying the i value by 90 is added to it.

Accordingly, a speed increase angle α of the steering shaft 2 can be obtained by the following formula.

α=90×i+β/2

Here, i is the i value (−8, −7 . . . 6, 7), and β is the offset correction periodic angle.

The speed increasing side detecting gear 4 is accelerated to be twice as fast as the rotor gear 3, and therefore, by detecting the rotating state of the speed increasing side detecting gear 4, the rotating state of the rotor gear 3 can be detected with double resolution.

Accordingly, the speed increase angle converted by the steering angle converting part 63 becomes a detailed absolute angle as compared with the speed reduction angle converted by the steering angle converting part 74.

Only when the ignition is turned on and the rotational angle of the steering shaft 2 is detected first, the i value is outputted from the speed reducing mechanism side operation part 70 to the speed increasing mechanism side operation part 60, and from then on, the steering angle converting part 63 itself increases or decreases the i value in accordance with the change in the offset correction periodic angle, and operates the speed increase angle by using the i value which is increased or decreased and the offset correction periodic angle.

The detailed speed increase angle of the steering shaft thus obtained is outputted to an external device such as a vehicle control device as a steering angle.

For the details of the above described steering angle detection, the description of Japanese Patent Application No. 2006-228581 is cited.

The failure diagnosis part 80 includes a speed increase angle moving averaging processing part 81 which calculates the moving average value of the speed increase angle output from the steering angle converting part 63 of the speed increasing mechanism side operation part 60, and a speed reduction angle moving averaging processing part 82 which calculates the moving average value of the speed reduction angle output from the steering angle converting part 74 of the speed reducing mechanism side operation part 70, a difference calculating part 84 which calculates the difference of the moving average values calculated by both the moving averaging processing parts, a displacement amount calculating part 86 which calculates a displacement amount with time of the difference, and an abnormality detecting part 88 which outputs a failure diagnosis result by determining presence or absence of abnormality based on the displacement amount of the difference.

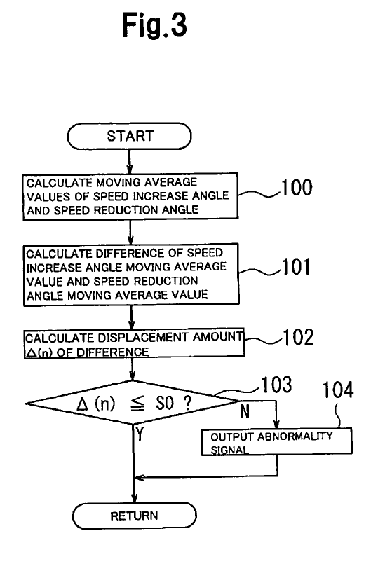

FIG. 3 is a flowchart showing the flow of abnormality detection processing in the failure diagnosis part 80.

First, when the speed increase angle and the speed reduction angle are outputted from the speed increasing mechanism side operation part 60 and the speed reducing mechanism side operation part 70, the speed increase angle moving averaging processing part 81, which receives the speed increase angle and the speed reduction angle, obtains a moving average value θai(n) from the following formula by using the continuous past plurality (m) of speed increase angles, at each sampling at an interval of 10 msec (n=1, 2, 3, . . . ) in step 100.

θai(n)={θi(n)+θi(n−1)+θi(n−2)+θi(n−3)+ . . . +θi(n−(m−1))}/m

where θi(n) is the speed increase angle.

Further, in the speed reduction angle moving averaging processing part 82, a moving average value θad(n) is likewise obtained from the following formula.

θad(n)={θd(n)+θd(n−1)+θd(n−2)+θd(n−3)+ . . . +θd(n−(m−1))}/m

where θd(n) is the speed reduction angle.

In the next step 101, the difference calculating part 84 obtains a difference θsub(n) of the moving average values from the following formula.

θsub(n)=θai(n)−θad(n)

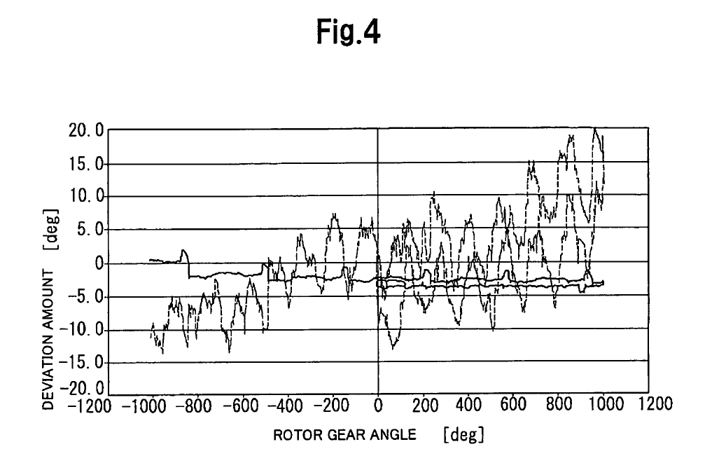

Thereby, the deviation amount of the speed increase angle with respect to an encoder angle when the rotor gear has tooth omission, and the deviation amount of the speed reduction angle with respect to the speed increase angle are as shown in FIG. 4. The solid line shows the deviation amount of the speed reduction angle with respect to the speed increase angle, and the broken line shows the deviation amount of the speed increase angle with respect to the encoder angle.

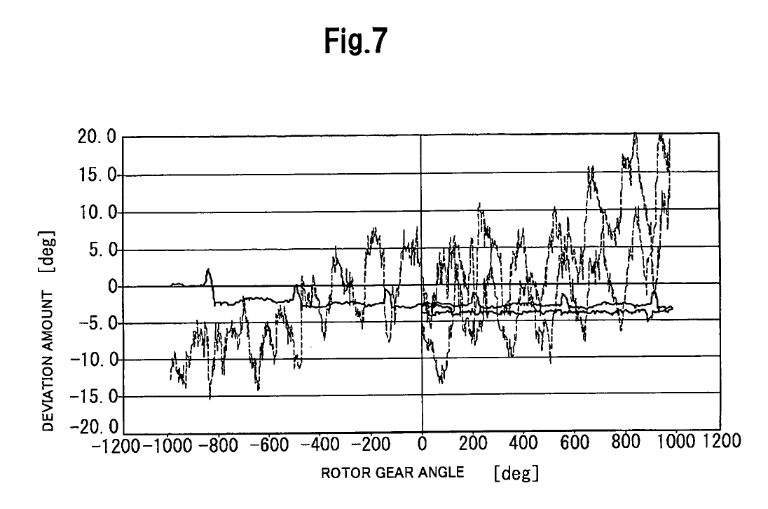

It is found out that small noises are reduced as compared with FIG. 7 previously shown.

In step 102, the displacement amount calculating part 86 calculates the consecutive displace amount of the difference θsub(n), that is, a displacement amount Δ(n) at the sampling interval from the following formula.

Δ(n)=θsub(n)−θsub(n−1)

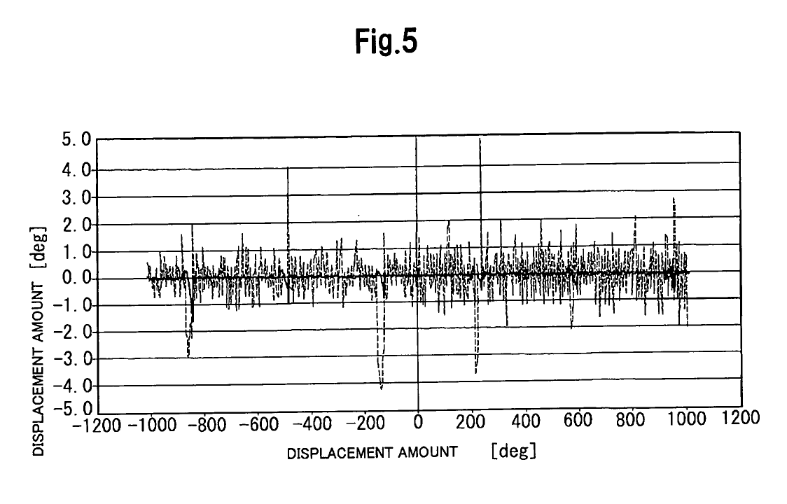

FIG. 5 shows the result of the above described processing in the case with tooth omission.

When the displacement amount of the difference between the previous time and the difference of the present time is obtained at each sampling after the deviation of the speed reduction angle with respect to the speed increase angle is obtained as the difference of the moving average values, as shown in FIG. 5, most of the displacement amounts of the deviation amounts (difference Δ(n)) of the speed reduction angle with respect to the speed increase angle shown by the solid line is within the predetermined range, and the changes which are outstanding from the other portions appear only in the positions at constant intervals.

When the displacement amount of the deviation of the speed increase angle with respect to the encoder angle is similarly obtained, the displacement amount keeps substantially zero, and changes are seen in the positions of the angles corresponding to tooth omission, as shown in FIG. 5. The outstanding change portions of the displacement amount of the difference Δ(n) of the speed reduction angle with respect to the speed increase angle correspond to the positions of them.

In FIG. 5, most of the displacement amounts of the deviation amounts of the speed reduction angle with respect to the speed increase angle are within the range of −1.0° to +1.0°.

In step 103, the abnormality detecting part 88 compares the displacement amount of the above described difference with a predetermined reference value S0. In the example of FIG. 5, if the reference value S0 is set as reference value S0=12.001 (absolute value), only the abnormality by tooth omission can be detected.

When the displacement amount of the difference is the reference value S0 or less, abnormality by tooth omission is determined as absent, and the flow of this time is terminated, and the flow returns to step 100.

When the displacement amount of the difference is larger than the reference value S0, an abnormality signal is outputted as the failure diagnosis result in step 104. The external device, which receives the signal, executes predetermined processing responding to the abnormality which is set in advance. After that, the flow is terminated.

In the present embodiment, the steering shaft 2 corresponds to the measurement target rotary element, the speed increasing side detecting gear 4 corresponds to the first driven gear, and the speed reducing side detecting gear 6 corresponds to the second driven gear.

The magnet 8a fixed to the speed increasing side detecting gear 4 and the MR sensor 7a opposed to the magnet 8a configure the first angle sensor, and the magnet 8b fixed to the speed reducing side detecting gear 6 and the MR sensor 7b opposed to the magnet 8b configure the second angle sensor.

The speed increasing mechanism side operation part 60 corresponds to the first angle calculating means, and the speed reducing mechanism side operation part 70 corresponds to the second angle calculating means.

Step 100 in the flowchart of FIG. 3 configures the moving averaging processing means, step 101 configures the difference calculating means, step 102 configures the displacement amount calculating means, and step 103 configures the abnormality detecting means.

The present embodiment is configured as above. The speed increasing side detecting gear 4 and the speed reducing side detecting gear 6 are rotated in conjunction with the rotor gear 3 rotated integrally with the steering shaft 2. The MR sensors 7a and 7b are opposed to the magnets 8a and 8b fixed to the speed increasing side detecting gear 4 and the speed reducing side detecting gear 6. Operation processing of the sampling data from the respective MR sensors is performed in the speed increasing mechanism side operation part 60 and the speed reducing mechanism side operation part 70 to calculate the speed increase angle and the speed reduction angle which are the absolute rotational angles of the steering shaft 2 respectively. The speed increase angle is set as the steering angle as the measurement output. The respective moving average values of the speed increase angles and the speed reduction angles are calculated in the speed increase angle moving averaging processing part 81 and the speed reduction angle moving averaging processing part 82. The difference of the respective moving average values is calculated in the difference calculating part 84. The displacement amount of the difference at each sampling is calculated in the displacement amount calculating part 86, and when the displacement amount is larger than the predetermined reference value S0, the abnormality detecting part 88 outputs the abnormal signal to the effect that any of the conjunction systems of the respective gears has tooth omission abnormality.

When the displacement amount of the difference between the previous time and the difference of the present time is obtained at each sampling after the deviation of the speed increase angle and the speed reduction angle is obtained as the difference of the moving average value, a large deflection which extremely differs from the other portions appears in only the angle position corresponding to the tooth omission as shown in FIG. 5, and therefore, the abnormality can be clearly detected.

The respective numeral values shown in the present embodiment are only examples, and the present invention is not limited to them.

Further, in the i value calculating part 73 of the speed reducing mechanism side operation part 70, the i value corresponding to the offset correction periodic angle relating to the speed reducing side detecting gear 6 is calculated, and the speed increase angle is obtained by using the i value in the speed increasing mechanism side operation part 60, but in the steering angle converting part 63 of the speed increasing mechanism side operation part 60, the speed increase angle may be obtained by referring to the speed reduction angle obtained in the speed reducing mechanism side operation part 70.

While only the selected embodiment has been chosen to illustrate the present invention, it will be apparent to those skilled in the art from this disclosure that various changes and modifications can be made therein without departing from the scope of the invention as defined in the appended claims

Furthermore, the foregoing description of the embodiment according to the present invention is provided for illustration only, and not for the purpose of limiting the invention as defined by the appended claims and their equivalents.

### DESCRIPTION OF THE CODES

2 STEERING SHAFT
3 ROTOR GEAR
4 SPEED INCREASING SIDE DETECTING GEAR
5 SPEED REDUCTION MECHANISM
6 SPEED REDUCING SIDE DETECTING GEAR
7a, 7b MR SENSOR
8a, 8b MAGNET
10 CASE BASE PLATE
47 EEPROM
50A, 51A FIRST DETECTING PART
50B, 51B SECOND DETECTING PART
60 SPEED INCREASING MECHANISM SIDE OPERATION PART
61, 71 PERIODIC ANGLE OPERATION PART
62, 72 OFFSET CORRECTING PART
63, 74 STEERING ANGLE CONVERTING PART
70 SPEED REDUCING MECHANISM SIDE OPERATION PART
73 iVALUE CALCULATING PART
80 FAILURE DIAGNOSIS PART
81 SPEED INCREASE ANGLE MOVING AVERAGING PROCESSING PART
82 SPEED REDUCTION ANGLE MOVING AVERAGING PROCESSING PART
84 DIFFERENCE CALCULATING PART
86 DISPLACEMENT AMOUNT CALCULATING PART
88 ABNORMALITY DETECTING PART

What is claimed is:

1. A rotational angle detecting device comprising a rotor gear rotating integrally with a measurement target rotating element, a first driven gear and a second driven gear rotating in conjunction with the rotor gear, a first angle sensor provided to be attached to the first driven gear to detect a periodic angle position of the first driven gear, a second angle sensor provided to be attached to the second driven gear to detect a periodic angle position of the second driven gear, first angle calculating means which performs operation processing of sampling data from the first angle sensor to calculate a first absolute rotational angle of the measurement target rotating element, and second angle calculating means which performs operation processing of sampling data from the second angle sensor to calculate a second absolute rotational angle of the measurement target rotating element, the rotational angle detecting device, comprising:
moving averaging processing means which calculates respective moving average values of the first absolute rotational angle and the second absolute rotational angle;
difference calculating means which calculates a difference between the moving average value of the first absolute rotational angle and the moving average value of the second absolute rotational angle;
displacement amount calculating means which calculates a displacement amount of the difference at each sampling; and
abnormality detecting means which outputs an abnormality signal to the effect that any of conjunction systems of the respective gears has gear tooth omission abnormality, when the displacement amount exceeds a predetermined reference value range.
